(19) United States
(12) Patent Application Publication
(10) Pub. No.: US 2024/0338083 A1
(43) Pub. Date: Oct. 10, 2024

(54) TACTILE KEYBOARD AND TACTILE INPUT DEVICE

(71) Applicant: CK MATERIALS LAB CO., LTD., Ansan-si Gyeonggi-do (KR)

(72) Inventors: Hyeong Jun KIM, Ansan-si Gyeonggi-do (KR); Jeen Gi KIM, Ansan-si Gyeonggi-do (KR); In Sik JEE, Ansan-si Gyeonggi-do (KR)

(73) Assignee: CK MATERIALS LAB CO., LTD., Ansan-si Gyeonggi-do (KR)

(21) Appl. No.: 18/748,222

(22) Filed: Jun. 20, 2024

Related U.S. Application Data
(63) Continuation of application No. PCT/KR2022/010872, filed on Jul. 25, 2022.

(30) Foreign Application Priority Data
Dec. 31, 2021 (KR) 10-2021-0193797
Mar. 2, 2022 (KR) 10-2022-0026962

(51) Int. Cl. G06F 3/01; G06F 3/02; H01H 13/7065; H02K 33/02

(52) U.S. Cl. CPC G06F 3/016; G06F 3/0202; H01H 13/7065; H02K 33/02

(57) ABSTRACT

The present invention relates to a tactile keyboard and a tactile input device. The tactile keyboard according to the present invention, which includes a plurality of keys, comprises a base portion providing a region on which the plurality of keys are arranged, wherein at least one of the keys comprises: a magnetic field generator which is arranged on the base portion; a cap portion which provides one surface so that a user comes in contact with the surface to apply an external force; an elastic portion which is disposed between the base portion and the cap portion and elastically supports the cap portion; and a motion portion which is at least partially connected to the cap portion and includes an elastic material, in which magnetic particles are distributed in a matrix.

### CROSS-REFERENCE TO RELATED APPLICATIONS

This application is a continuation of International Application No. PCT/KR2022/010872 filed on Jul. 25, 2022, which claims priority to Korean Patent Application No. 10-2021-0193797 filed on Dec. 31, 2021 and Korean Patent Application No. 10-2022-0026962 filed on Mar. 2, 2022, the entire contents of which are herein incorporated by reference.

### TECHNICAL FIELD

The present invention relates to a tactile keyboard and a tactile input device. More specifically, the present invention relates to a tactile keyboard and a tactile input device that allow a user to receive tactile sensations by contacting the keyboard or input device.

### BACKGROUND ART

With the advancement of computer technology, input methods using touch pads or voice recognition have been increasingly used to provide convenient interfaces for users. However, keyboards and mice are still the most widely used input devices.

Among these, the keyboard is the means that the user is in contact with for the longest time during the communication process between the user and the computer. However, feedback for input using the keyboard is limited to display on a screen and sound. In other words, feedback is limited to visual and auditory forms, and technologies that provide tactile feedback or provide tactile sensation from the keyboard itself to the user are rare.

Membrane keyboards, one type of keyboard, are the most popular and simple to manufacture, making them economical. However, they have the disadvantage of poor key feel. Since the elasticity of rubber domes is not excellent, it is difficult to convey distinctive tactile feedback other than the feeling of pressing a key.

Mechanical keyboards can provide a crisp typing sensation, and they have the advantage of being able to implement a different key feel simply by replacing a switch (axis). However, unless the switch (axis) is replaced, there are limitations in delivering various tactile sensations

A pantograph keyboard is a type of keyboard that combines a membrane keyboard mechanism with a pantograph structure which is an X-shaped support, and is primarily used in laptops. It has the advantage of being the quietest among keyboards, having a thin profile, and requiring light force to press keys. However, similar to membrane keyboards, it suffers from poor key feel and a significant risk of breakage.

### DETAILED DESCRIPTION OF THE INVENTION

### Technical Problem

An object of the present invention is to provide a tactile keyboard and a tactile input device capable of providing tactile sensations to a user and offering various forms of tactile sensations.

Additionally, another object of the present invention is to provide a tactile keyboard and a tactile input device which can be configured to be small and thin in size and can be driven with less energy.

However, these objects are exemplary and the scope of the present invention is not limited thereto.

### Technical Solution

The above object is achieved by a tactile keyboard having a plurality of keys, the tactile keyboard including a base portion configured to provide a region on which the plurality of keys are arranged, wherein at least one of the keys includes: a magnetic field generator arranged on the base portion; a cap portion configured to provide one surface so that a user comes in contact with the surface to apply an external force; an elastic portion disposed between the base portion and the cap portion and configured to elastically support the cap portion; and a motion portion at least partially connected to the cap portion and configured to include an elastic material, in which magnetic particles are dispersed in a matrix.

In addition, according to an embodiment of the present invention, the magnetic field generator may include a solenoid coil and apply a magnetic field to the motion portion.

Also, according to an embodiment of the present invention, a force generated in the motion portion as the magnetic particles react to a magnetic field applied from the magnetic field generator may be transmitted to the cap portion, thereby providing a tactile sensation to the user.

In addition, according to an embodiment of the present invention, the cap portion may include a first surface that a user makes contact with and applies an external force to and a second surface that is opposite to the first surface and on which the motion portion is arranged.

In addition, according to an embodiment of the present invention, a receiving groove may be formed on the second surface, and the motion portion may be accommodated and arranged in the receiving groove.

In addition, according to an embodiment of the present invention, the cap portion may be formed in a double-shot injection mold structure in which a hard material layer including the receiving groove and a soft material layer accommodated in the receiving groove are formed.

In addition, according to an embodiment of the present invention, the cap portion may include a first surface that the user makes contact with and applies an external force to, and a second surface opposite to the first surface, and the motion portion may be arranged on at least a portion of the first surface.

In addition, according to an embodiment of the present invention, the motion portion and the cap portion may be formed in a film-insert in-mold structure of the cap portion and a film portion that covers an elastic material in which magnetic particles are dispersed in a matrix.

In addition, according to an embodiment of the present invention, the elastic portion may include any one of a rubber dome, a spring, and a pantograph-shaped polymer support.

In addition, according to an embodiment of the present invention, the elastic portion may include a vertically formed shaft and a spring fitted onto the shaft.

In addition, according to an embodiment of the present invention, some keys include only the cap portion and the elastic portion and a specific key may include the magnetic field generator, the cap portion, the elastic portion, and the motion portion.

In addition, according to an embodiment of the present invention, the specific key may have a larger area than an average area of the plurality of keys.

In addition, according to an embodiment of the present invention, the tactile keyboard may further include a controller configured to transmit a signal to the magnetic field generator.

In addition, according to an embodiment of the present invention, the controller transmits a signal to a magnetic field generator of a key when a time duration for which the user presses the key exceeds a preset time

In addition, according to an embodiment of the present invention, the controller may include pattern data stored to provide a specific tactile sensation on a preset key and may transmit a signal to the magnetic field generator based on the pattern data.

In addition, according to an embodiment of the present invention, the controller may transmit a signal to the magnetic field generator based on at least one of event pattern data corresponding to an effect of an event or audio pattern data corresponding to an audio signal.

In addition, according to an embodiment of the present invention, the tactile keyboard may further include a function key, wherein the function key may be a key that turns on and off a magnetic field applied to the motion portion, adjusts intensity and frequency of the magnetic field applied to the motion portion, or transmits a signal of a pattern pre-stored in the motion portion to the magnetic field generator.

In addition, according to an embodiment of the present invention, the motion portion may be connected to an elastic support portion and the elastic support portion may be at least partially connected to the cap portion.

In addition, according to an embodiment of the present invention, the motion portion is divided into a plurality of region, each having a different polarity.

The above object is achieved by a tactile input device having at least one button, the tactile input device including a base portion configured to provide a region on which the button is arranged, wherein at least one of the button includes a magnetic field generator arranged on the base portion; a cap portion configured to provide one surface so that a user comes in contact with the surface to apply an external force; an elastic portion disposed between the base portion and the cap portion and configured to elastically support the cap portion; and a motion portion at least partially connected to the cap portion and configured to include an elastic material in which magnetic particles are dispersed in a matrix.

The above object is achieved by a method of providing a tactile sensation to a user using a tactile keyboard comprising a plurality of keys and a controller, wherein at least one of the keys includes a cap portion configured to provide one surface so that a user comes in contact with to apply an external force; a motion portion at least partially connected to the cap portion and configured to include an elastic material in which magnetic particles are dispersed in a matrix; and a magnetic field generator configured to generate a magnetic field which is applied to the motion portion, and the controller transmits a signal for application of a magnetic field to the magnetic field generator.

In addition, according to an embodiment of the present invention, the controller may transmit a signal to a magnetic field generator of a key when a time duration for which the user presses the key exceeds a preset time.

In addition, according to an embodiment of the present invention, the controller may include pattern data stored to provide a specific tactile sensation on a preset key and may transmit a signal to the magnetic field generator based on the pattern data.

In addition, according to an embodiment of the present invention, the controller may transmit a signal to the magnetic field generator based on at least one of event pattern data corresponding to an effect of an event or audio pattern data corresponding to an audio signal.

In addition, according to an embodiment of the present invention, the controller may transmit a signal to the magnetic field generator while the user is entering a letter or a symbol through the key or pressing the key.

In addition, according to an embodiment of the present invention, the controller may transmit a signal to the magnetic field generator after the user enters a letter or a symbol through the key.

In addition, according to an embodiment of the present invention, the controller may determine whether the user has completed entering a word or a sentence, and when it is determined that the entering is complete, the controller may transmit a signal to the magnetic field generator that corresponds to at least one key.

In addition, according to an embodiment of the present invention, the controller may determine whether the user has completed entering the word or the sentence, and when a typo occurs, the controller may transmit a signal, which is different from the signal transmitted upon completion of the entering, to the magnetic field generator that corresponds to at least one key.

In addition, according to an embodiment of the present invention, the controller may transmit a signal to the magnetic field generator that corresponds to a key group based on setting data of the key group received from setup software of the tactile keyboard.

Also, according to an embodiment of the present invention, the controller may transmit a signal to the magnetic field generator based on at least one of tactile sensation pattern data, tactile sensation intensity data, or tactile sensation providing duration data received from setup software of the tactile keyboard.

### Advantageous Effects

According to the present invention configured as described above, tactile sensations can be provided to a user and various forms of tactile sensations can be offered.

In addition, according to the present invention, a tactile keyboard and a tactile input device can be configured to be small and thin in size and can be driven with less energy.

However, the scope of the present invention is not limited by such effects.

### BRIEF DESCRIPTION OF DRAWINGS

FIG. 1 is a schematic view of a linear resonant actuator (LRA).

FIGS. 2A and 2B show schematic side cross-sectional view of a membrane keyboard and a mechanical keyboard.

FIG. 3 is a schematic diagram illustrating the configuration of a tactile keyboard according to an embodiment of the present invention.

FIG. 4 is a schematic diagram illustrating a cap portion formed in a double-shot injection molded structure according to an embodiment of the present invention.

FIG. 5 is a schematic view of a cap portion formed in a film-insert in-mold structure according to an embodiment of the present invention.

FIGS. 6, 7, 8, 9A, 9B, and 9C are schematic side cross-sectional views of keys according to various embodiments of the present invention.

FIG. 10 is a schematic diagram of a tactile setting screen according to an embodiment of the present invention.

FIGS. 11A, 11B, and 11C illustrate schematic diagrams showing forms of tactile sensation implementation on a keyboard according to an embodiment of the present invention.

FIGS. 12A, 12B, 12C, and 12D illustrate schematic side cross-sectional views of a key and schematic diagrams showing forms of tactile sensation implementation on a keyboard according to another embodiment of the present invention.

### REFERENCE NUMERALS

10: KEY
12: CAP PORTION
13: ELASTIC PORTION
14: MOTION PORTION
15: MAGNETIC FIELD GENERATOR
16: ELASTIC SUPPORT PORTION
20: FUNCTION KEY
100: TACTILE KEYBOARD, TACTILE INPUT DEVICE
110: BASE PORTION
130: CONTROLLER
150: COMMUNICATION UNIT

### DETAILED DESCRIPTION

The accompanying drawings, which show embodiments for illustrative purposes only, will be referred to. The embodiments will be described in sufficient detail for one of ordinary skill in the art to implement the present invention. It should be understood that various embodiments of the present invention may differ from each other but need not be mutually exclusive. For example, particular shapes, structures and characteristics disclosed herein in connection with one embodiment may be embodied in other embodiments without departing from the spirit and scope of the present invention. In addition, it is to be understood that the position or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, similar reference numerals refer to the same or similar functions over various aspects, and the length, area, thickness, and the like and the form may be exaggerated for convenience.

The following description is given of embodiments of the present invention with reference to the attached drawings in such a manner that the present invention can be easily carried out by one of ordinary skill in the art.

A magneto-rheological elastomer (MRE) actuator, an inertial actuator, a piezoelectric actuator, an electro-active polymer (EAP) actuator, an electrostatic force actuator, etc. may be used for haptic technology and technology for providing tactile sensation.

The MRE actuator is composed of magnetic particles, matrix material, and a magnetic field generator, providing various tactile sensations depending on the intensity, direction, and frequency of the magnetic field. Examples of the inertial actuator include an eccentric motor that vibrates by an eccentric force generated by the rotation of the motor, and a linear resonant actuator (LRA) that maximizes the vibrational intensity by resonant frequencies. The piezoelectric actuator is in the shape of a beam or a disk and is driven by a piezoelectric element whose size or shape changes instantaneously in response to an electric field. The EAP actuator generates vibration by repeated movements of a mass attached to an EAP film. The electrostatic actuator is driven by an attractive force generated between two oppositely charged glass sheets and a repulsive force generated when the glass sheets have charges with the same polarity. In addition, tactile or haptic devices using shape memory alloys, macro-composite fiber, electrotactile sensations, electrostatic friction, ultrasonic waves, acoustic radiation pressure, and the like are being developed.

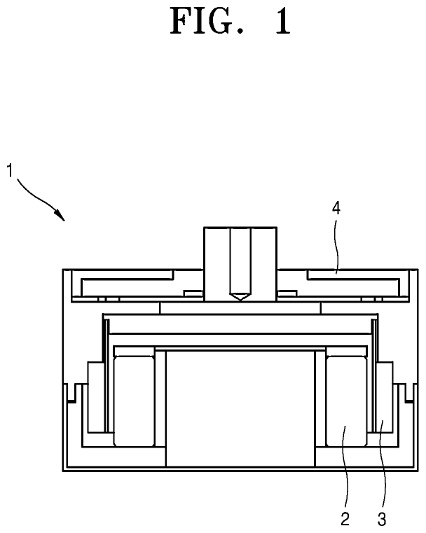

FIG. 1 is a schematic view of a linear resonant actuator (LRA) 1. A typical LRA 1 or linear vibration motor includes a magnet 2, a coil 3, a suspension 4, and other structures. The LRA 1 has excellent vibration force, but it is composed of several components and thus has a structural limitation for lowering the height thereof. Also, the LRA 1 is difficult to apply to products that require a local vibration force since a vibration force is transmitted to the entire structure which surrounds the motor or is in proximity to the motor.

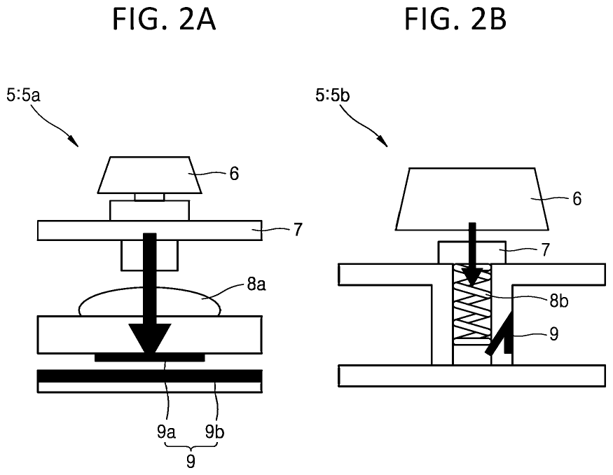

FIGS. 2A and 2B shows schematic side cross-sectional views of a membrane keyboard 5 (5a) and a mechanical keyboard 5 (5b).

The membrane keyboard 5a in FIG. 2A includes a keycap 6, a switch 7, a rubber dome 8a, and contact points 9 (9a and 9b). The membrane keyboard 5a has a structure in which, when a user presses the keycap 6, the switch 7 connected to the keycap 6 compresses the upper portion of the rubber dome 8a, causing a pair of contact points 9 (9a and 9b) to touch each other and transmit an input signal. When the user releases the external force applied to the keycap 6, the keycap 6 may return to its upper position due to the elasticity of the rubber dome 8a. The mechanical keyboard 5b in FIG. 2B includes a keycap 6, a switch 7, a spring 8b, and a contact point 9. The mechanical keyboard 5b has a structure in which, when the user presses the keycap 6, the switch 7 connected to the keycap 6 compresses and pushes down the spring 8b, causing the contact point 9 to bend and make contact, thereby transmitting an input signal. When the user releases the external force applied to the keycap 6, the keycap 6 returns to its upper position due to the elasticity of the spring 8b. In addition, there are also pantograph keyboards and plunger keyboards.

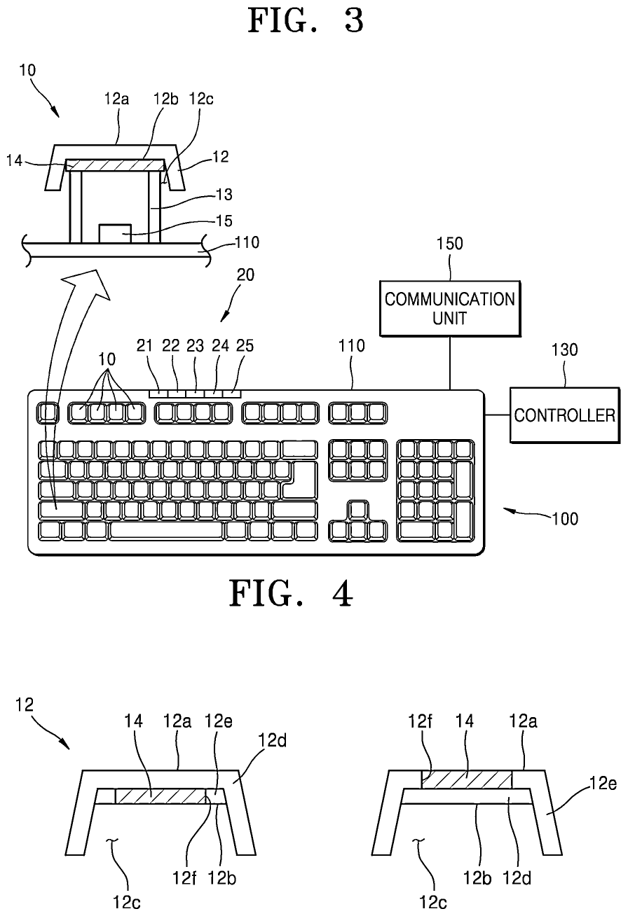

FIG. 3 is a schematic diagram illustrating the configuration of a tactile keyboard 100 according to an embodiment of the present invention. The tactile keyboard 100 according to an embodiment of the present invention may provide tactile sensations to a user by applying an elastic material, such as MRE, in which magnetic particles are dispersed in a matrix, to the membrane keyboard, mechanical keyboard, or the like described above with reference to FIGS. 2A and 2B.

The tactile keyboard 100 may include a plurality of keys 10. The plurality of keys 10 may be arranged on a base portion 110. The base portion 110 is the base plate of the tactile keyboard 100 and may function as a housing. There is no limit to the number of keys 10, such as in a 101-key keyboard or 104-key keyboard. Additionally, function keys 20 related to the tactile implementation of the present invention may be further arranged on the base portion 110, separate from the input keys 10. The structure of the input keys 10 and the function keys 20 may be identical. An elastic material, such as MRE, in which magnetic particles are dispersed in a matrix, may be applied to the function keys 20 as well as the input keys 10 to provide tactile sensations.

The tactile keyboard 100 may include a controller 130 and a communication unit 150. The controller 130 and the communication unit 150 may be embedded in the tactile keyboard 100 or provided as wiring extending from the tactile keyboard 100 to the outside. The controller 130 may include one or more processors and one or more memory modules.

The controller 130 performs a series of operations related to the control of the tactile keyboard 100. The controller 130 may convert a signal input to the input key 10 into a signal that can be used by an input target device (e.g., a computer). Additionally, the controller 130 may convert a signal input to the function key 20 into a signal that controls the form of tactile sensation implementation on the tactile keyboard 100. Moreover, it may generate signals that deliver various patterns of tactile sensations to the user based on data received from the input target device or external device. Furthermore, it may deliver the power supplied from a power supply unit (not shown) to the keys 10 and 20 and a magnetic field generator 15.

The communication unit 150 may transmit and receive data to and from the input target device, external device, etc. The communication unit 150 may use any means to transmit and receive data via wireless or wired connections without limitations.

Referring to the enlarged view in FIG. 3, at least one of the plurality of keys 10 may adopt a configuration for transmitting tactile sensations. The key 10 may include a cap portion 12, an elastic portion 13, a motion portion 14, and the magnetic field generator 15. Also, it may further include a contact point (not shown) that is a means of making electrical contact with the base portion 110.

The cap portion 12 serves as a cover of the key 10. An upper surface 12a of the cap portion 12 is formed to a size that allows the user to apply external force. The cap portion 12 may be in the form of a flat plate or an inverted bowl to cover the components of the key 10.

The cap portion 12 includes a first surface 12a that comes in contact with the user (the user's finger) and receives external force, and a second surface 12b opposite to the first surface 12a. The motion portion 14 may be arranged on the second surface 12b.

According to an embodiment, a receiving groove 12c may be formed on the second surface 12b such that the motion portion 14 can be fixedly supported on the cap portion 12. It is preferable that the receiving groove 12c has a shape corresponding to the motion portion 14, but any shape that allows the insertion of the motion portion 14 is acceptable. The motion portion 14 may be received in the receiving groove 12c and fixedly supported on the second surface 12b of the cap portion 12.

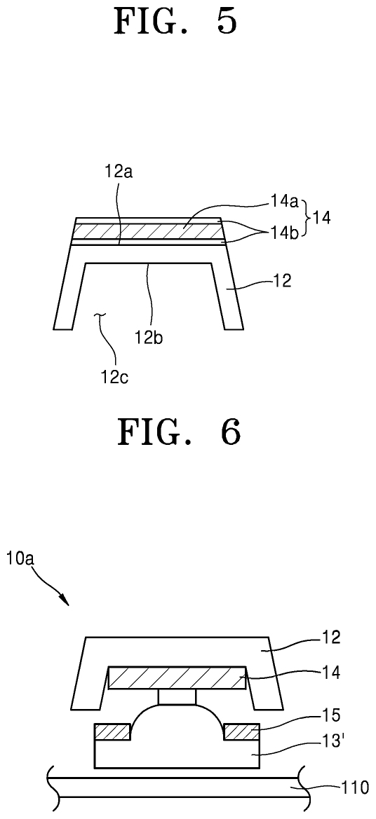

FIG. 4 is a schematic diagram illustrating a cap portion formed in a double-shot injection molded structure according to an embodiment of the present invention.

According to an embodiment, the cap portion 12 may be formed in a double-shot injection molded structure comprising a soft material layer 12d and a hard material layer 12e. Referring to the left diagram of FIG. 4, the soft material layer 12d may provide the first surface 12a of the cap portion 12, and the hard material layer 12e may provide the second surface 12b of the cap portion 12. Additionally, in the double-shot injection molded structure, the hard material layer may be formed to include a hole 12f. The motion portion 14 may be inserted and arranged in the hole 12f. The soft material layer 12d may include a receiving groove 12c, and the hard material layer 12e and the motion portion 14 may be accommodated within the receiving groove 12c. The soft material layer 12d may include a soft material such as thermoplastic polyurethane (TPU), thermoplastic elastomer (TPE), or the like, while the hard material layer 12e may include a hard material such as polycarbonate (PC).

Since the first surface 12a of the soft material layer 12d, which is an upper layer, comes into contact with the user, forces such as vibrations generated by the motion portion 14 may be better transmitted to the upper portion. In addition, since the central portion of the hard material layer 12e, which is a lower layer, is hollow in the form of a hole 12f, a local force may be generated in the central portion by the motion portion 14 more effectively than in the outer portion. The local force may be transmitted to the upper portion through the soft material layer 12d, which is the upper layer.

Referring to the right diagram of FIG. 4, conversely, the hard material layer 12e may provide the first surface 12a of the cap portion 12, and the soft material layer 12d may provide the second surface 12b of the cap portion 12. Additionally, in the double-shot injection molded structure, the hard material layer may be formed to include a hole 12f. The motion portion 14 may be inserted and arranged in the hole 12f. The hard material layer 12e may include the receiving groove 12c, and the soft material layer 12d may be accommodated within the receiving groove 12c.

Since the first surface 12a of the hard material layer 12e, which is the upper layer, comes into contact with the user and the motion portion 14 is inserted and arranged in the hole 12f of the hard material layer 12e, forces such as vibrations generated by the motion portion 14 may be directly transmitted to the user. In addition, a local force generated by the motion portion 14 may be transmitted more effectively in the central portion than in the outer portion of the hard material layer 12e. The soft material layer 12d may protect the cap portion 12 and the components arranged below the cap portion 12 from an external force applied to the cap portion 12.

The elastic portion 13 may be arranged between the base portion 110 and the cap portion 12. The elastic portion 13 may support the cap portion 12. When the user applies an external force to the cap portion 12, the elastic portion 13 may provide a key feel due to the resistance force, and when the user's external force is released, it may return the cap portion 12 to its upper position.

The motion portion 14 may include an elastic material in which magnetic particles are dispersed in a matrix. For example, the motion portion 14 may include a magneto-rheological elastomer (MRE), or configured itself as a magneto-rheological elastomer.

In one example, the magnetic particles may be selected from at least one of iron, carbonyl iron, iron alloy, iron oxide, iron nitride, iron carbide, low carbon steel, nickel, cobalt, and mixtures thereof, or alloys thereof. Additionally, the magnetic particles may be uncoated magnetic particles or magnetic particles coated with an organic resin. The matrix material may be any polymer, such as natural rubber or synthetic rubber.

A conventional magneto-rheological elastomer actuator implements haptic feedback based on the changes in the shape of a magneto-rheological elastomer caused by an attractive or repulsive force as the polarities N and S of a magnetic field generated by the solenoid coil alternate with the frequency. The magneto-rheological elastomer actuator has a simple structure, allowing it to be made thin and compact, and it may be applied in various ways through changes in the shape of the magneto-rheological elastomer material, providing a local vibration force. The present invention applies the magneto-rheological elastomer to the motion portion 14 to provide haptic tactile sensations in a tactile keyboards and a tactile input device. Here, the tactile sensation includes not only vibration, tapping, and twist but also sensations with patterns, rhythms, and directionality.

The motion portion 14 may preferably have a thin and flat shape such that the key 10 can be configured to be thin, but there are no restrictions on its shape to allow for a variety of tactile patterns. The motion portion 14 may generate force as the magnetic particles in the motion portion 14 react to the applied magnetic field. As the shape or position of the motion portion 14 changes, a force that provides a tactile sensation may be generated Furthermore, a force that provides a tactile sensation may be generated by changes in flexibility, stiffness, and the like in response to the application of a magnetic field to the motion portion 14. For example, the motion portion 14 may move up and down in response to attractive and repulsive forces created by the magnetic field applied from the magnetic field generator 15 according to the magnetic polarity. The motion portion 14 may convey a tactile sensation by striking the first surface 12a or the second surface 12b of the cap portion 12 as it moves up and down. Alternatively, for example, if the motion portion 14 changes its shape or a position of at least part of the motion portion 14 changes as a magnetic field is applied to the motion portion 14, this change may be transmitted to the cap portion 12, conveying a tactile sensation to the user in contact with the cap portion 12. Additionally, when a magnetic field is applied to the motion portion 14 and the stiffness changes, a tactile sensation may be transmitted to the user in contact with the key 10 through the changed stiffness.

According to an embodiment, the motion portion 14 may be at least partially connected to the cap portion 12. Therefore, when a magnetic field is applied to the motion portion 14 and the magnetic particles of the motion portion 14 react, a force such as vibration is generated in the motion portion 14, and is transmitted through the connected portion to the cap portion 12, delivering a tactile sensation to the user in contact with the cap portion 12.

In addition, according to an embodiment, the motion portion 14 may be in close contact with the second surface 12b of the cap portion 12. The force transmitted to the second surface 12b may be provided as a tactile sensation to the user in contact with the first surface 12a. Moreover, since the motion portion 14 is in close contact with the cap portion 12, even by slight changes in shape, position, flexibility, or stiffness, a tactile sensation may be generated on the surfaces 12a and 12b of the cap portion 12 that the user can perceive.

Furthermore, according to an embodiment, the motion portion 14 may be formed in a shape corresponding to the second surface 12b of the cap portion 12. The motion portion 14 is not just formed in a flat shape but may be formed in an inverted bowl shape corresponding to the receiving groove 12c of the second surface 12b. As a result, the cap portion 12 and the motion portion 14 are in close contact over a larger surface area, allowing the transmission of stronger tactile sensations.

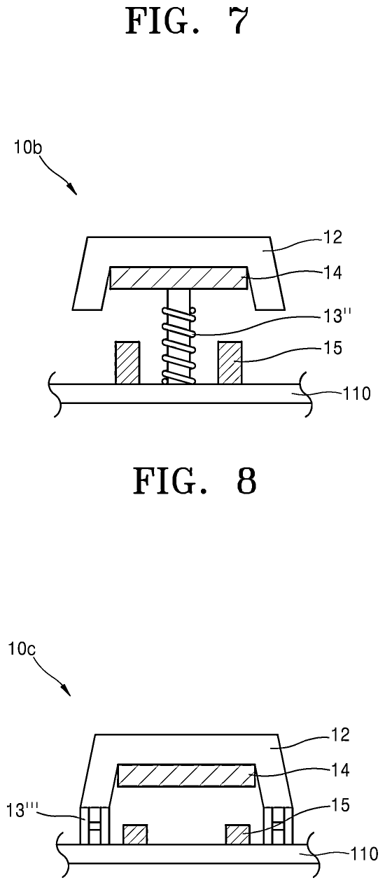

FIG. 5 is a schematic view of a cap portion formed in a film-insert in-mold structure according to an embodiment of the present invention.

The motion portion 14 may be formed on the first surface 12a of the cap portion 12. The motion portion 14 may be formed to be close contact with the cap portion 12 or be integrally formed with it. According to an embodiment, the motion portion 14 may be connected to the cap portion 12 using a film insert in-mold structure. The method of forming the cap portion 12 and motion portion 14 using the film insert in-mold process is as follows.

An elastic material 14a, in which magnetic particles are dispersed in a matrix, may be at least partially covered with a film portion 14b. The film portion 14b may cover both sides of the elastic material 14a, but it may also cover only one side. Then, the film portion 14b covering the elastic material 14a may be placed in a mold. A pre-heating process may also be performed. While the film portion 14b covering the elastic material 14a is pressed in the mold, a material for forming the cap portion 12 may be injected into the mold. Accordingly, manufacturing of a structure in which the motion portion 14 and the cap portion 12 are integrally formed may be completed.

Since the upper surface of the motion portion 14 is in direct contact with the user, the force generated by the motion portion 14 may be immediately transmitted to the user. In addition, since the elastic material 14a is covered by the film portion 14b, the elastic material 14a may be protected from repeated contact with the user. Moreover, because the motion portion 14 is formed to be thin, it does not significantly affect the thickness of the key 10. Furthermore, the user in direct contact with the motion portion 14 can easily detect tactile sensations from the motion portion 14 due to slight changes resulting from the application of a small magnetic field.

The magnetic field generator 15 may be arranged on the base portion 110. The magnetic field generator 15 may generate a magnetic field using the power transmitted from the controller 130. The magnetic field generator 15 may use means to control the direction of the magnetic field. Preferably, the magnetic field generator 15 may include a solenoid coil and change the direction of the magnetic field by controlling the direction of the flowing current.

The magnetic field generator 15 may be positioned below the motion portion 14, preferably directly below the central portion of the motion portion 14. The magnetic field generator 15 may be arranged to apply a magnetic field from the bottom to the top of the motion portion 14. By applying a magnetic field from the magnetic field generator 15 to the motion portion 14 spaced apart above the magnetic field generator 15, the motion portion 14 may move up and down. Meanwhile, the magnetic field generator 15 may also be placed diagonally or staggered relative to the motion portion 14 to change the form in which the magnetic field is applied. In this case, the movement pattern of the motion portion 14 may be changed.

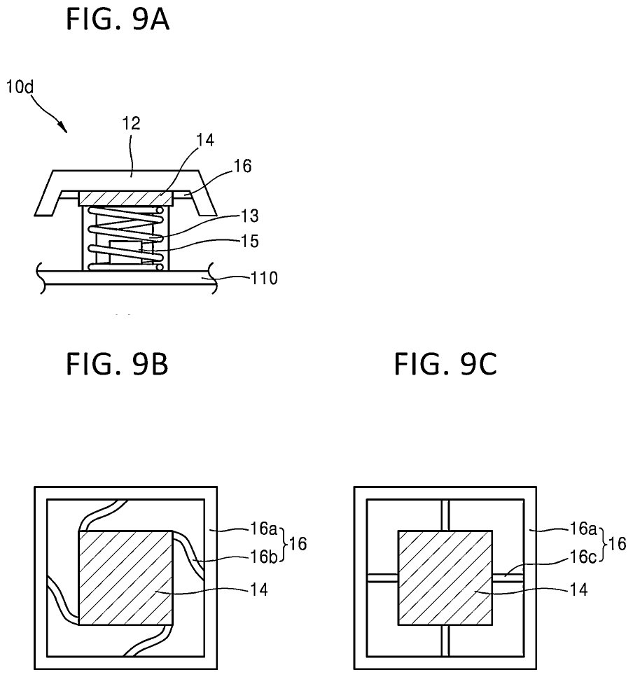

FIGS. 6 to 9 are schematic side cross-sectional views of keys 10 (10a to 10d) according to various embodiments of the present invention.

FIG. 6 shows a key 10a where a motion portion 14 is applied to a membrane keyboard. An elastic portion 13′ may use a rubber dome, as used in a membrane keyboard. The motion portion 14 may be connected to a second surface 12b of a cap portion 12, and a magnetic field generator 15 may be positioned above or around the rubber dome to apply a magnetic field to the motion portion 14. Instead of the rubber dome, a spring or other elastic means may be used as the elastic portion 13′.

FIG. 7 shows a key 10b in which a motion portion 14 is applied to a mechanical keyboard. An elastic portion 13″ may include a vertically formed shaft and a spring fitted onto the shaft, as used in a membrane keyboard. The motion portion 14 may be connected to a second surface 12b of a cap portion 12, and a magnetic field generator 15 may be positioned around the spring and the shaft to apply a magnetic field to the motion portion 14.

FIG. 8 shows a key 10c in which a motion portion 14 is applied to a pantograph keyboard. An elastic portion 13′″ may use a pantograph-shaped polymer support, as commonly used in a pantograph keyboard. The motion portion 14 may be connected to a second surface 12b of a cap portion 12, and a magnetic field generator 15 may be positioned around the support to apply a magnetic field to the motion portion 14.

Of course, as shown in FIG. 5, in the embodiments shown in FIGS. 6 to 8, the motion portion 14 may also be connected to the first surface 12a of the cap portion 12.

FIG. 9A shows an embodiment in which the motion portion 14 is connected to an elastic support portion 16 and the elastic support portion 16 is at least partially connected to the cap portion 12.

Referring to FIGS. 9B and 9C, the elastic support portion 16 may include an edge portion 16a and a connecting portion 16b. The edge portion 16a and the connection portion 16b may be integrally formed or connected as separate elements. The edge portion 16a forms the outer edge frame of the elastic support portion 16, and the edge portion 16a may be at least partially connected to the cap portion 12. FIG. 9A shows a structure in which the outer edge of the edge portion 16a is connected to the cap portion 12 as the motion portion 14 and the elastic support portion 16 are accommodated in the receiving groove 12c of the cap portion 12. The connecting portion 16b may connect the edge portion 16a and the motion portion 14. Although four connecting portions 16b are illustrated in FIG. 9B, one or more connecting portions 16b may be provided as long as the connection portion 16b connects the edge portion 16a and the motion portion 14.

The connecting portion 16b may provide spring elasticity such that the motion portion 14 can be supported by the edge portion 16a and can move up and down. To this end, the connecting portion 16b is preferably formed longer than the rectilinear distance from the edge portion 16a to the motion portion 14. If the length of the connecting portion 16b is the same as the rectilinear distance from the edge portion 16a to the motion portion 14, vertical movement might be difficult. As shown in FIG. 9B, the connecting portion 16b preferably has a curved shape or a shape with multiple curvatures. Alternatively, as shown in FIG. 9C, if the connecting portion 16b is made of a stretchable material, it may extend in a straight line from each side of the edge portion 16a and be connected to the motion portion 14. In addition, the elastic support portion 16 is not limited to the shape or material shown in FIGS. 9A, 9B, and 9C, as long as it vertically drives the motion portion 14 with its spring tension.

According to the embodiment shown in FIGS. 9A, 9B, and 9C, a tactile sensation may be achieved by combining the vibration of the motion portion 14 created in response to the application of a magnetic field and the spring tension of the elastic support portion 16. There is an advantage that even with the application of energy less than the energy required for the motion portion 14 to move vertically, the momentum can be increased due to the spring elasticity of the elastic support portion 16. In addition, the elastic material of the motion portion 14, such as MRE, in which magnetic particles are dispersed in a matrix, is also driven while undergoing micro-deformation in response to the magnetic field, and vibration is realized by the combination of the spring motion of the elastic support portion 16 and the deformation force of the elastic material, such as MRE, in which magnetic particles are dispersed in a matrix, in response to the application of the magnetic field. Thus, it is possible to produce vibrations having tactile patterns that go beyond simple vibrations.

The controller 130 may generate signals to deliver tactile sensations of various patterns to the user based on data received from an input target device (e.g., a computer) or other external devices. The controller 130 may generate a signal to control the operation of the key on the tactile keyboard based on events generated on a display of the input target device or audio signals. The controller 130 may generate a control signal for the motion portion 14 based on event pattern data corresponding to the effect of an event or audio pattern data corresponding to an audio signal. For example, in the process of executing an event where an object moves on the display, tactile sensations may be implemented on the up, down, left, and right directional keys of the keyboard to correspond to the movement of the object. In another example, tactile sensations may be implemented in the keys used in the game while background music or sound effects are generated in the game. The control signal controls the operating frequency, intensity, waveform, and the like of the motion portion 14 such that tactile sensations with various patterns in addition to constant vibration tactile sensation can be implemented.

Meanwhile, according to an embodiment, all keys 10 may include the cap portion 12, the elastic portion 13, the motion portion 14, and a magnetic field generator 15. Additionally, according to an embodiment, some keys 10 may include only the cap portion 12 and the elastic portion 13 as described above with reference to FIGS. 2A and 2B, and only specific keys 10 may include the cap portion 12, the elastic portion 13, the motion portion 14, and the magnetic field generator 15.

These specific keys 10 may have a larger area than the average area of the other keys. For example, on a 104-key keyboard, keys such as Enter, Shift, Ctrl, Alt, and Space, which are formed with a larger area than keys such as numbers 0 to 9 and alphabets A to Z, may be designated as specific keys. A larger area of the motion portion 14 can be connected to the specific keys having a relatively larger area, making it easier to implement a tactile sensation of strength that the user can readily perceive. In addition, keys such as numbers 0 to 9 and alphabets A to Z are pressed for a shorter duration (shorter contact time with the user), whereas the specific keys may have a longer pressing duration (longer contact time with the user), making it easier to convey a tactile sensation.

For example, keys like Shift, Ctrl, and Alt are not used alone but are mostly pressed in combination with other keys, which may result in a longer pressing duration. For another example, when playing a game, the user may not use all the keys on the keyboard but only the directional keys and action keys such as Enter, Shift, Ctrl, Alt, and Space. In this case, the user's fingers are mostly in contact with the directional keys and action keys, leading to longer contact time and making it easier to effectively convey a tactile sensation.

Moreover, keys on the keyboard that serve as reference points for the user's fingers may be designated as specific keys. For example, keys such as F ( [symbol] ), J ( [symbol] ), and 5 on a numeric keypad have protrusions to help the user find the reference position without looking at the keyboard. As an alternative, if these keys periodically vibrate, the user may receive a tactile sensation and can easily recognize the reference position.

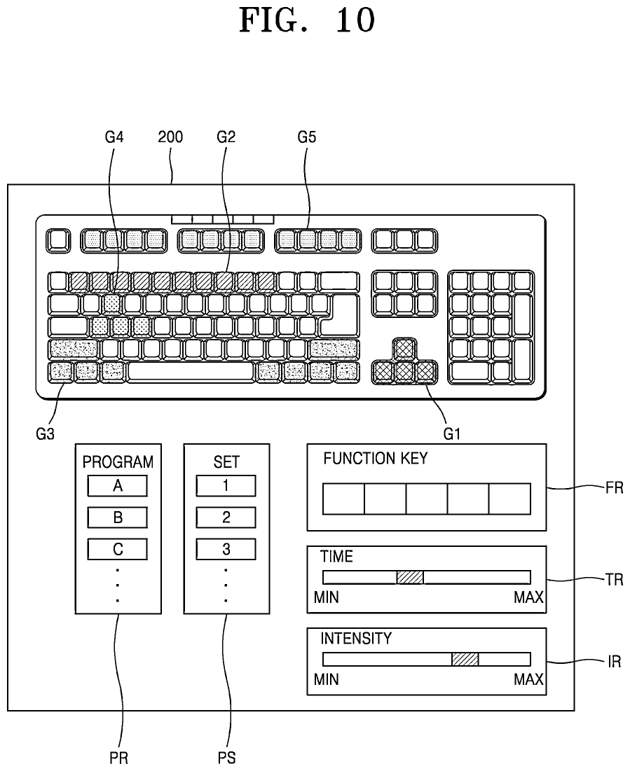

FIG. 10 is a schematic diagram of a tactile setting screen 200 according to an embodiment of the present invention.

A tactile keyboard 100 of the present invention may execute setup software to configure the form of tactile sensation implementation in an adjustment window. Alternatively, the form of tactile sensation implementation may be set using function keys, adjustment buttons, and the like provided by a tactile keyboard device. For example, a tactile sensation may be set to be implemented only when a specific program PR is running, or it may be set to be implemented for each option PS of different programs. Another example is that tactile patterns may be separately set for specific key groups (directional key group G1, 0-9 number group G2, Shift/Ctrl/Alt group G3, WASD group G4, F1-F12 group G5, etc.). In another example, conditions for implementing a tactile sensation on a specific key (such as the threshold pressing time, threshold intensity of event/audio signals, etc.) may also be set. In another example, settings for the duration TR of tactile sensation and the intensity IR of tactile sensation may also be set.

According to an embodiment, the minimum key press time required to implement a tactile sensation may be set. The controller 130 may transmit an operational signal to the magnetic field generator 15 if the time duration for which the user presses a key exceeds a preset time. If the user presses and releases the key quickly, it may be difficult to ensure enough time to receive a tactile sensation. Therefore, the controller may determine whether the user maintains contact with the key long enough for a tactile sensation to be effectively delivered and then operate the motion portion 14.

According to an embodiment, the controller 130 may include pattern data stored to provide a specific tactile sensation on a key preset through the setup software. In addition, based on the pattern data, the controller 130 may transmit a signal to the magnetic field generator 15 to operate the motion portion 14.

Function keys 20 (21 to 25) may be provided on the tactile keyboard 100 to immediately control the tactile sensations implemented. For example, a function key 21 may turn the tactile sensation on or off on the tactile keyboard 100 by turning on/off the application of a magnetic field to the motion portion 14. Function keys 22 and 23 may increase or decrease the intensity of the tactile sensation. Function keys 24 and 25 may speed up or slow down the period of the tactile sensation. In addition, the function key 20 may be used to transmit a signal of the pre-stored pattern to the magnetic field generator 15. Moreover, it is possible to preset functions FR associated with the function keys 20 through the setup software.

Meanwhile, the controller 130 may transmit an operational signal to the magnetic field generator 15 to provide a tactile sensation for the letter entered by the user using the keyboard. According to an embodiment, the user may receive a tactile sensation while entering a letter, a symbol, or the like or pressing a specific key. The user may immediately receive a tactile sensation while typing or pressing the key 10. A feedback tactile sensation may be provided as the operation associated with one key 10 or multiple keys 10.

According to another embodiment, after entering a letter, symbol, or the like, the user may receive a tactile sensation as a feedback for the completion of entering. The user may receive a tactile sensation after typing on the key 10. A feedback tactile sensation may be provided as the operation associated with one key 10 or multiple keys 10.

According to still another embodiment, upon completing the entering of a word or sentence, the user may receive a tactile sensation for the completion of entering. The controller 130 may include data related to words, sentences, and the like, or access data stored in the setup software to perform a verification process for the completion of entering. If it is determined that the entering is complete, the controller 130 may perform an operation for one or more keys 10 to generate a feedback tactile sensation. If there is a typo in the word or sentence during or after the user's entering, i.e., if the controller 130 does not determine that the entering is complete, it may generate a feedback tactile sensation for the typo that is distinct from the feedback tactile sensation for the completion of entering.

Meanwhile, the controller 130 may control the magnetic field generator 15 to apply a high-frequency magnetic field to the motion portion 14. The motion portion 14 may vibrate at a high frequency and produce audible sound. This audible sound may be generated corresponding to the user's typing on the key 10. The key 10 that produces the audible sound do not necessarily have to be the key being typed by the user but may be one or more keys 10 of the tactile keyboard 100. The volume of the audible sound may be adjusted according to the number of keys 10 producing the audible sound. For example, as the tactile keyboard 100 generates audible sound, the user may experience typing sounds similar to those of a mechanical keyboard, even if the keyboard does not have a mechanical keyboard structure. At the same time, the feel of the key 10 during input may be changed according to changes in the shape, position, flexibility, and stiffness of the motion portion 14, thereby enhancing the user experience to further resemble that of a mechanical keyboard. In another example, the tactile keyboard 100 may generate audible sound corresponding to the event effect or audio signal in the running software, in addition to providing a tactile sensation corresponding to the event effect or audio signal. In still another example, the tactile keyboard 100 may include an audible sound speaker unit (not shown) to produce the audible sound.

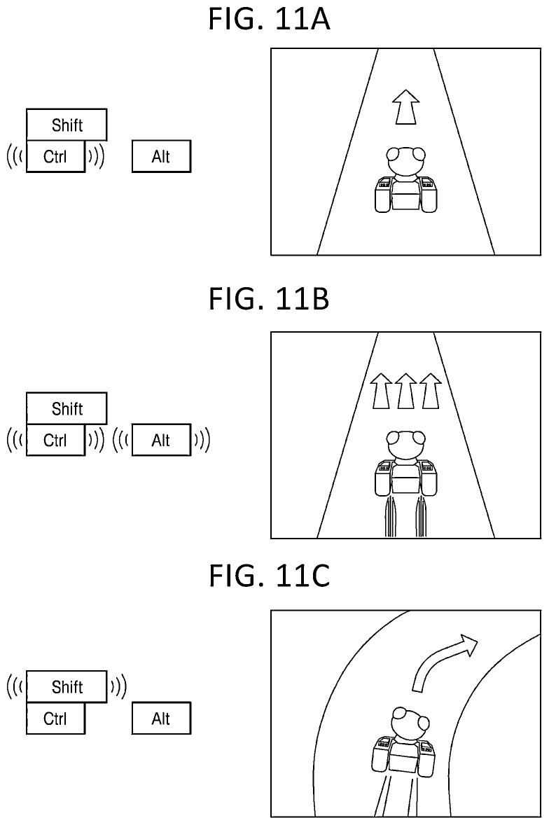

FIGS. 11A, 11B, and 11C illustrate schematic diagrams showing forms of tactile sensation implementation on a keyboard according to an embodiment of the present invention.

FIGS. 11A, 11B, and 11C illustrate the form of tactile sensation implementation on a keyboard when running a racing game. Generally, when playing a game, not all keys are used, but only a few keys are utilized. For instance, in a car racing game, the Ctrl key may be used for using items, the Alt key for the booster, and the Shift key for the brake function. A user may play the game while placing three fingers of his/her left hand on Ctrl, Alt, and Shift keys and the fingers of his/her right hand on the up, down, left, and right directional keys. In other words, the three fingers of the user's left hand maintain contact with Ctrl, Alt, and Shift keys.

When a car is accelerated in a straight line as shown in FIG. 11A, the motion portion 14 may continuously operate at the Ctrl position to generate a tactile sensation. The user may feel the car accelerating through the tactile sensation by recognizing the tactile sensation at the Ctrl position even with or without pressing Ctrl. When the car goes even faster using booster as shown in FIG. 11B, the motion portion 14 may operate at both the Ctrl and Alt positions to generate a tactile sensation. The user may feel the car accelerating further through the tactile sensations by pressing the Alt key to use the booster and at the same time recognizing the tactile sensations at both Ctrl and Alt positions. When the car makes a turn as shown in FIG. 11C, the motion portion 14 may operate at the Shift position to generate a tactile sensation. The user may feel the car decelerating and turning by pressing the Shift key to reduce speed and make the turn and at the same time recognizing the tactile feedback at the Shift position.

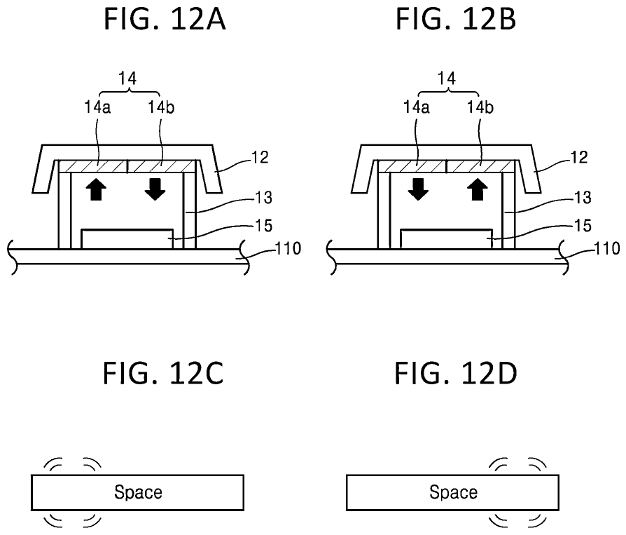

FIGS. 12A, 12B, 12C, and 12D illustrate schematic side cross-sectional views of a key and schematic diagrams showing forms of tactile sensation implementation on a keyboard according to another embodiment of the present invention.

Referring to FIGS. 12A and 12B, the motion portion 14 may be divided into a plurality of regions 14a and 14b, each having a different polarity. As shown in FIG. 12A, in response to the application of the same magnetic field, a region 14a may move in the upper direction while region 14b may move in the lower direction. As shown in FIG. 12B, in response to the application of a magnetic field in the opposite direction, the region 14a may move in the lower direction while the region 14b may move in the upper direction. For example, if the motion portion 14 operates as shown in FIG. 12A, a tactile sensation may be delivered to the left side of the cap portion 12 of the Space key as shown in FIG. 12C. Conversely, if the motion portion 14 operates as shown in FIG. 12B, a tactile sensation may be delivered to the right side of the cap portion 12 of the Space key as shown in FIG. 12D.

Accordingly, the motion portion 14 may twist or move up and down in a zigzag pattern, making it possible to provide various tactile sensations depending on the position of the key 10.

Additionally, a tactile sensation may be delivered to each region of the cap portion 12 by continuously changing the direction of the magnetic field applied to the motion portion 14. For this purpose, a plurality of magnetic field generators 15 may be arranged in a single key 10. The tactile sensation may be conveyed to the user by moving the location at which the tactile sensation is generated on the cap portion 12. For example, when a cursor or an object moves on the computer display screen, the tactile sensation may move on the key 10 to correspond to the movement direction. It is apparent that the tactile sensation can also move from one key to an adjacent key within a group of multiple keys.

While the tactile keyboard 100 has been described as an example, the configuration of the key 10 for implementing a tactile sensation according to the present invention may also be applied to a mouse, tact switch, and the like. In this case, the key 10 may be replaced with a button form. One or more buttons may be included. Thus, the present invention can be provided as a series of tactile input devices that deliver a tactile sensation to the user in devices equipped with buttons, including tactile keyboards, laptops, desktops, phones, other IT devices, automobiles, home appliances, and the like.

As described above, the tactile keyboard and the tactile input device according to the present invention can provide a tactile sensation to the user and offer various forms of tactile sensations. In addition, as the present invention uses an elastic material in which MRE magnetic particles are dispersed in a matrix, a smaller and thinner tactile sensation delivering key can be implemented as compared to the conventional LRA shown in FIG. 1, and can be driven with less energy.

Although the present invention has been shown and described with reference to a preferred embodiment as described above, the present invention is not limited to the above embodiment, and within the scope without departing from the spirit of the present invention, various modifications and changes can be made by those skilled in the art. It should be considered that such modification example and change example belong to the scopes of the present invention and the appended claims.

1. A tactile keyboard having a plurality of keys, the tactile keyboard comprising a base portion configured to provide a region on which the plurality of keys are arranged,
wherein at least one of the keys comprises: a magnetic field generator arranged on the base portion;
a cap portion configured to provide one surface so that a user comes in contact with the surface to apply an external force;
an elastic portion disposed between the base portion and the cap portion and configured to elastically support the cap portion; and
a motion portion at least partially connected to the cap portion and configured to include an elastic material in which magnetic particles are dispersed in a matrix.

2. The tactile keyboard of claim 1, wherein the magnetic field generator comprises a solenoid coil and applies a magnetic field to the motion portion.

3. The tactile keyboard of claim 1, wherein a force generated in the motion portion as the magnetic particles react to a magnetic field applied from the magnetic field generator is transmitted to the cap portion, thereby providing a tactile sensation to the user.

4. The tactile keyboard of claim 1, wherein the cap portion comprises a first surface that a user makes contact with and applies an external force to and a second surface that is opposite to the first surface and on which the motion portion is arranged.

5. The tactile keyboard of claim 4, wherein a receiving groove is formed on the second surface, and the motion portion is accommodated and arranged in the receiving groove.

6. The tactile keyboard of claim 5, wherein the cap portion is formed in a double-shot injection mold structure in which a hard material layer comprising the receiving groove and a soft material layer accommodated in the receiving groove are formed.

7. The tactile keyboard of claim 1, wherein the cap portion comprises a first surface that the user makes contact with and applies an external force to, and a second surface opposite to the first surface, and the motion portion is arranged on at least a portion of the first surface.

8. The tactile keyboard of claim 1, wherein the motion portion and the cap portion are formed in a film-insert in-mold structure of the cap portion and a film portion that covers an elastic material in which magnetic particles are dispersed in a matrix.

9. The tactile keyboard of claim 1, wherein the elastic portion comprises any one of a rubber dome, a spring, and a pantograph-shaped polymer support.

10. The tactile keyboard of claim 1, wherein the elastic portion comprises a vertically formed shaft and a spring fitted onto the shaft.

11. The tactile keyboard of claim 1, wherein some keys comprise only the cap portion and the elastic portion and a specific key comprises the magnetic field generator, the cap portion, the elastic portion, and the motion portion.

12. The tactile keyboard of claim 11, wherein the specific key has a larger area than an average area of the plurality of keys.

13. The tactile keyboard of claim 1, further comprising a controller configured to transmit a signal to the magnetic field generator.

14. The tactile keyboard of claim 13, wherein the controller transmits a signal to a magnetic field generator of a key when a time duration for which the user presses the key exceeds a preset time.

15. The tactile keyboard of claim 13, wherein the controller includes pattern data stored to provide a specific tactile sensation on a preset key and transmits a signal to the magnetic field generator based on the pattern data.

16. The tactile keyboard of claim 13, wherein the controller transmits a signal to the magnetic field generator based on at least one of event pattern data corresponding to an effect of an event or audio pattern data corresponding to an audio signal.

17. The tactile keyboard of claim 1, further comprising a function key,
wherein the function key is a key that turns on and off a magnetic field applied to the motion portion, adjusts intensity and frequency of the magnetic field applied to the motion portion, or transmits a signal of a pattern pre-stored in the motion portion to the magnetic field generator.

18. The tactile keyboard of claim 1, wherein the motion portion is connected to an elastic support portion and the elastic support portion is at least partially connected to the cap portion.

19. The tactile keyboard of claim 1, wherein the motion portion is divided into a plurality of region, each having a different polarity.

20. A tactile input device having at least one button, the tactile input device comprising a base portion configured to provide a region on which the button is arranged,
wherein at least one of the button comprises:
a magnetic field generator arranged on the base portion;
a cap portion configured to provide one surface so that a user comes in contact with the surface to apply an external force;
an elastic portion disposed between the base portion and the cap portion and configured to elastically support the cap portion; and
a motion portion at least partially connected to the cap portion and configured to include an elastic material in which magnetic particles are dispersed in a matrix.

21. A method of providing a tactile sensation to a user using a tactile keyboard comprising a plurality of keys and a controller,
wherein at least one of the keys comprises
a cap portion configured to provide one surface so that a user comes in contact with to apply an external force;
a motion portion at least partially connected to the cap portion and configured to include an elastic material in which magnetic particles are dispersed in a matrix; and
a magnetic field generator configured to generate a magnetic field which is applied to the motion portion, and
the controller transmits a signal for application of a magnetic field to the magnetic field generator.

22. The method of claim 21, wherein the controller determines whether the user has completed entering a word or a sentence, and when it is determined that the entering is complete, the controller transmits a signal to the magnetic field generator that corresponds to at least one key.

23. The method of claim 22, wherein the controller determines whether the user has completed entering the word or the sentence, and when a typo occurs, the controller transmits a signal, which is different from the signal transmitted upon completion of the entering, to the magnetic field generator that corresponds to at least one key.

24. The method of claim 21, wherein the controller transmits a signal to the magnetic field generator that corresponds to a key group based on setting data of the key group received from setup software of the tactile keyboard.

25. The method of claim 21, wherein the controller transmits a signal to the magnetic field generator based on at least one of tactile sensation pattern data, tactile sensation intensity data, or tactile sensation providing duration data received from setup software of the tactile keyboard.
